(19) United States
(12) Patent Application Publication
(10) Pub. No.: US 2012/0310656 A1
(43) Pub. Date: Dec. 6, 2012

(54) REMOTE VENDING MACHINE CONTROLLER

(75) Inventors: Oliver Joerg STACHE, Niederkruechten (DE); Antonio Solano Tarroc, Madrid (ES); Andreas Nils Walter Cronstrom, Malmo (SE); Susana Margarida Cardim Cabaco, Carnaxide (PT); Tiago Andre Dias Do Naschiento Pergira Camilo, Quinta do Anjo (PT); Damian Czernous, Wroclaw (PL)

(73) Assignee: NOKIA SIEMENS NETWORKS OY, Espoo (FI)

(21) Appl. No.: 13/151,446

(22) Filed: Jun. 2, 2011

(51) Int. Cl. G06Q 30/00

(52) U.S. Cl. 705/1.1

(57) ABSTRACT

A vending machine controller is described that is able to communicate with a number of vending machines in a vending machine system and a number of potential users of those vending machines (typically by sending messages to communication devices of those users). The controller is able to set prices of items in vending machines, wherein a particular price for a product can be dependent not only of the identity of the products itself, but also on the identity of the vending machine selling the product and even the identity of the user purchasing the product.

The invention relates to vending machines. In particular, the invention relates to vending machines that are able to interact with other devices, such as mobile communication devices.

Vending machine technology is well established. Such machines typically dispense relatively low value items, such as snacks and drinks, in significant quantities.

Vending machines are not generally flexible. Products are available at fixed prices and, when sold out, need to be replaced. The period of such replacements can be unpredictable. Vending machines do not lend themselves to providing flexible marketing campaigns that offer discounted products without requiring an engineer to visit the vending machine to configure the machine. Vending machines also do not lend themselves to providing products at prices that are dependent on the identity of the purchaser.

The present invention seeks to address at least some of the problems outlined above.

The present invention provides a vending machine controller comprising a processor configured to set prices for one or more products available for sale at one or more of a plurality of vending machines under the control of the vending machine controller, wherein at least one of said prices is dependent on (at least) the identity of a purchaser of the product. In many forms of the invention, at least one of said prices is dependent on (at least) the identity of the vending machine selling the product.

The controller may further comprise a first interface configured to provide price data to at least some of the plurality of vending machines.

The controller may comprise a second interface configured to provide price data to one or more mobile communication devices used to identify one or more purchasers. The second interface may be used to send information relating to a promotion to one or more selected users selected from said plurality of users.

In the use of the system a user obtains a product at a price assigned to them by identifying the mobile communication device of that user at one of said plurality of vending machines.

The present invention also provides mobile communication device comprising a first interface and a second interface, wherein: the first interface is configured to receive price data for one or more products available for sale at one or more of a plurality of vending machines, wherein at least one of said prices is dependent on (at least) the identity of a user of the mobile communication device; and the second interface is configured to identify the user to one or more of the said vending machines.

Thus, the user obtains a product at a price assigned to them by identifying the mobile communication device of that user at one of said plurality of vending machines.

In many forms of the invention, at least one of said prices is dependent on (at least) the identity of the vending machine selling the product.

The present invention further provides a vending machine comprising: a first interface configured to receive price data from a vending machine controller, wherein the price data sets prices for one or more products available for sale at the vending machine, wherein at least one of said prices is dependent on (at least) the identity of a purchaser of the product; a second interface configured to receive data identifying a mobile communication device at the vending machine, wherein the identity of the mobile communication device is used to identify the purchaser of a product; a processor configured to set a price for the product dependent on the identity of the purchaser. In the event that a price is not defined for a particular user, then a default price may be used.

The present invention yet further provides a method of setting a price, the method comprising: using a processor to select one or more of a plurality of vending machines under the control of the processor for which the price applies; using the processor to select one or more users for which the price applies; and using a communications network to inform the selected vending machines and/or the selected user(s) of the price. Thus, the price can be set that is dependent on the vending machine and/or the purchaser of a product. The communications network may be a mobile communications network.

In the use of the system a user obtains a product at a price assigned to them by identifying the mobile communication device of that user at one of said plurality of vending machines.

The present invention also provides a method comprising: receiving price data at a mobile communication device for one or more products available for sale at one or more of a plurality of vending machines, wherein at least one of said prices is dependent on (at least) the identity of a purchaser of the user of the mobile communication device; and identifying the mobile communication device to a vending machine in order to access a product at a price indicated by said price data.

Thus, the user can obtain a product at a price assigned to them by identifying the mobile communication device of that user at one of said plurality of vending machines.

In many forms of the invention, at least one of said prices is dependent on (at least) the identity of the vending machine selling the product.

The present invention also provides a method comprising: receiving price data at a vending machine from a vending machine controller, wherein the price data sets prices for one or more products available for sale at the vending machine, wherein at least one of said prices is dependent on (at least) the identity of a purchaser of the product; receiving data identifying a mobile communication device at the vending machine, wherein the identity of the mobile communication device is used to identify the purchaser; and determining a price for a product requested by the purchaser, as defined by said price data.

In the event that a price is not defined for a particular user, then a default price may be used.

The present invention also provides a computer program comprising: means for using a processor to select one or more of a plurality of vending machines under the control of the processor for which the price applies; means for using the processor to select one or more users for which the price applies; and means for using a communications network to inform the selected vending machines and/or the selected user(s) of the price.

The present invention further provides a computer program comprising: means for receiving price data at a mobile communication device for one or more products available for sale at one or more of a plurality of vending machines, wherein at least one of said prices is dependent on (at least) the identity of a purchaser of the user of the mobile communication device; and means for identifying the mobile communication device to a vending machine in order to access a product at a price indicated by said price data.

The present invention yet further provides a computer program product comprising: means for receiving price data from a vending machine controller, wherein the price data sets prices for one or more products available for sale at a vending machine, wherein at least one of said prices is dependent on (at least) the identity of a purchaser of the product; means for receiving data identifying a mobile communication device at the vending machine, wherein the identity of the mobile communication device is used to identify the purchaser; and means for determining a price for a product requested by the user depending on the price data applicable.

Exemplary embodiments of the invention are described below, by way of example only, with reference to the following numbered drawings.

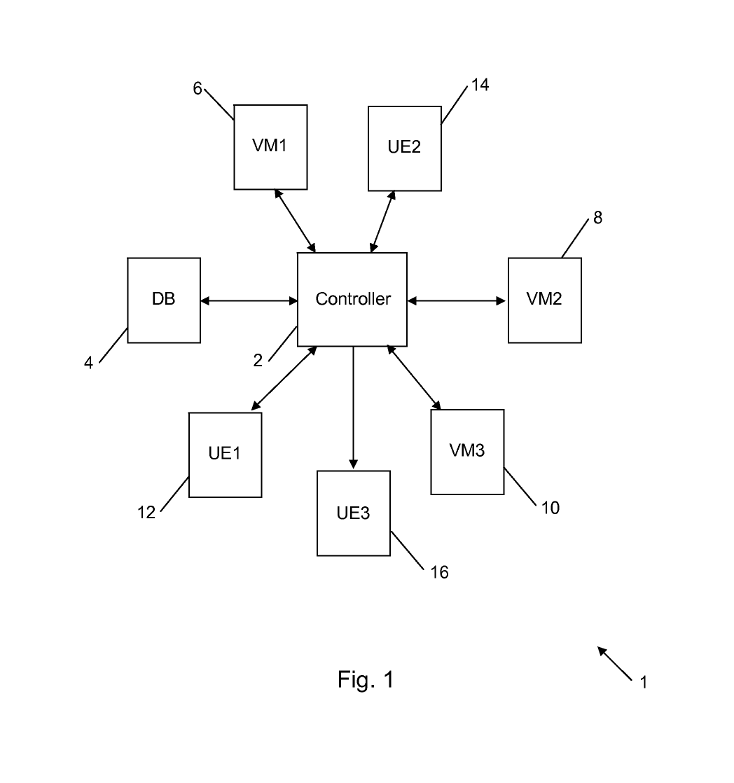

FIG. 1 is a block diagram of a system in accordance with an aspect of the present invention;

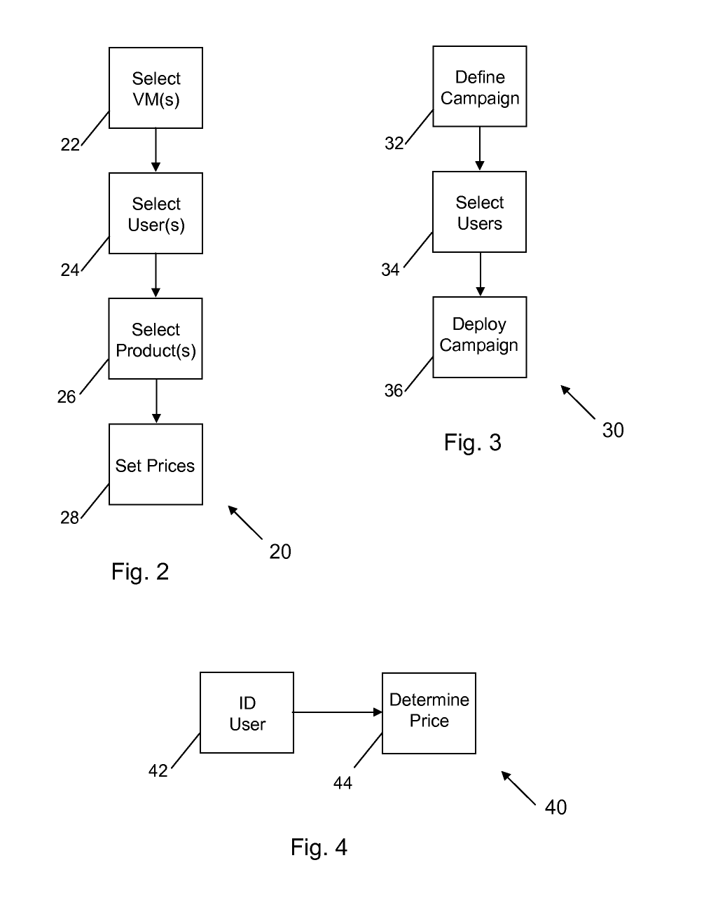

FIG. 2 is a flow chart showing an algorithm in accordance with an aspect of the present invention;

FIG. 3 is a flow chart showing an algorithm in accordance with an aspect of the present invention; and

FIG. 4 is a flow chart showing an algorithm in accordance with an aspect of the present invention.

FIG. 1 is a block diagram of a system, indicated generally by the reference numeral 1, in accordance with an aspect of the present invention. The system 1 comprises a controller 2, a database 4, a first vending machine 6, a second vending machine 8, a third vending machine 10, a first mobile communication device 12, a second mobile communication device 14 and a third mobile communication device 16. The mobile communication devices are used by potential or actual vending machine customers. As shown in FIG. 1, the controller 2 is in two-way communication with the database, the first, second and third vending machines and the first, second and third mobile communication devices.

FIG. 2 is a flow chart showing an algorithm, indicated generally by the reference numeral 20, in accordance with an aspect of the present invention. The algorithm 20 is used by the central controller 2 to set prices of products in one or more of the vending machines 6, 8 and 10 in the system 1.

The algorithm 20 starts at step 22, wherein the central controller 2 selects one or more vending machines for which a particular price is applicable. In some embodiments, the price may be set for all vending machines under the control of the central controller. In other embodiments, the price may be set for fewer than all of the vending machines under the control of the central controller. Price data may be stored in the database 4.

Next, at step 24, the central controller selects one or more users for which the price will be applicable. Again, as with the step 22, the price may be set for all users, or may be set for fewer than all users. In the system 1, the users are identified by the mobile communication devices. Thus, for example, the central controller may indicate that a particular price being set is applicable to the user of the first mobile communication device 14 only.

The algorithm 20 then moves to step 26, where the central controller selects one or more products for which the price will be applicable. Finally, the price is set at step 28.

Clearly, the steps of the algorithm 20 could be carried out in any order. The particular order shown in FIG. 2 is provided by way of example only.

Consider, for example, a scenario in which the central controller is monitoring the sales of a first product in each of the first, second and third vending machines 6, 8 and 10. Assume that the first product is selling well in the first and second vending machines 6 and 8, but is selling poorly in the third vending machine 10.

Following the algorithm 20, the central controller 2 may decide that the first product should be sold at a discounted rate in the third vending machine 10. Thus, the third vending machine 10 is selected in step 22 of the algorithm. The central controller decides that the algorithm should be applicable to all purchasers of the first product (step 24) and the product is identified in step 26. Finally, the vending machine 10 is informed of the new price for the product in step 28. The revised price may be stored in the database 4.

In the scenario described above, the central controller may only want to offer the discount for selected users. For example, the discount may be applied only for users who have signed up to a particular scheme. Those users may be identified in step 24, so that users who are not part of the scheme would pay the normal price and those who have signed up to the relevant scheme would pay the discounted price.

FIG. 3 is a flow chart showing an algorithm, indicated generally by the reference numeral 30, showing an exemplary method in accordance with an aspect of the present invention.

The algorithm 30 starts at step 32 where a campaign is defined. A particular campaign may define an offer in which a product is offered at a reduced price for a limited period of time. The campaign may offer the reduced price based on one or more of the identity of the vending machine and the identity of products. For example, a first product may be offered at half price for a limited period from a limited group of vending machines. Accordingly, the step 32 of the algorithm may be based largely on the algorithm 20 described above.

The algorithm 30 moves to step 34 where users for which the campaign applied. The users selected in the step 34 may be based on a pre-defined mailing list. For example, users may sign up to a mailing list by sending an SMS message from their mobile communication device to a given number.

Finally, at step 36, details of the campaign are sent to the vending machines to which the campaign applies and to the users to which the campaign applies.

FIG. 4 is a flow chart showing an algorithm, indicated generally by the reference numeral 40, showing how a user purchases a product at a price defined for that user.

The algorithm 40 starts at step 42, where the user is identified at the vending machine in some way. The step 42 can be implemented in many ways. For example, the user may use his mobile communication device as an identification means. For example, the mobile communication device may be equipped to use near-field communications to communicate with a vending machine. Alternatively, the mobile communication device may display a barcode sent from the controller 2 to the mobile communication device. A barcode reader on the vending machine can then be used to identify the user. The skilled person will be aware of many other ways of implementing the steps 42, such as entering a PIN code at the vending machine that has been sent to the mobile communication device by the central controller 2 in an SMS message.

With the user identified, the algorithm 40 moves to step 44, where the price for the particular product is determined. If the price is dependent on the identity of the user, then the vending machine either consults a local database to determine the price that should be applied for the identified or use, or the vending machine consults the central controller 2 to determine the price that should be applied.

With the price identified, the user can be charged the correct price (for example, as defined in the campaign 32) and the product dispensed.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. A vending machine controller comprising:
a processor configured to set prices for one or more products available for sale at one or more of a plurality of vending machines under the control of the vending machine controller, wherein at least one of said prices is dependent on the identity of a purchaser of the product; and
a first interface configured to provide price data to at least one of the plurality of vending machines.

2. A vending machine controller as claimed in claim 1, wherein at least one of said prices is dependent on the identity of the vending machine selling the product.

3. A vending machine controller as claimed in claim 1, further comprising a second interface configured to provide price data to one or more mobile communication devices used to identify one or more purchasers.

4. A mobile communication device comprising a first interface and a second interface, wherein:
the first interface is configured to receive price data for one or more products available for sale at one or more of a plurality of vending machines, wherein at least one of said prices is dependent on the identity of a user of the mobile communication device; and
the second interface is configured to identify the user to one or more of the said vending machines.

5. A vending machine comprising:
a first interface configured to receive price data from a vending machine controller, wherein the price data sets prices for one or more products available for sale at the vending machine, wherein at least one of said prices is dependent on the identity of a purchaser of the product;
a second interface configured to receive data identifying a mobile communication device at the vending machine, wherein the identity of the mobile communication device is used to identify the purchaser of a product; and
a processor configured to set a price for the product dependent on the identity of the purchaser.

6. A method of setting a price, the method comprising:
using a processor to select one or more of a plurality of vending machines under the control of the processor for which the price applies;
using the processor to select one or more users for which the price applies; and
using a communications network to inform the selected vending machines and/or the selected user(s) of the price.

7. A method as claimed in claim 6, wherein the communications network is a mobile communications network.

8. A method comprising:
receiving price data at a mobile communication device for one or more products available for sale at one or more of a plurality of vending machines, wherein at least one of said prices is dependent on the identity of a purchaser of the user of the mobile communication device; and
identifying the mobile communication device to a vending machine in order to access a product at a price indicated by said price data.

9. A method comprising:
receiving price data at a vending machine from a vending machine controller, wherein the price data sets prices for one or more products available for sale at the vending machine, wherein at least one of said prices is dependent on the identity of a purchaser of the product;
receiving data identifying a mobile communication device at the vending machine, wherein the identity of the mobile communication device is used to identify the purchaser; and
determining a price for a product requested by the purchaser, as defined by said price data.

10. A computer program product comprising:
means for using a processor to select one or more of a plurality of vending machines under the control of the processor for which the price applies;
means for using the processor to select one or more users for which the price applies; and
means for using a communications network to inform the selected vending machines and/or the selected user(s) of the price.

11. A computer program product embodied on a computer-readable medium, said computer program including instructions which, when run on a processor, control said processor to perform:
receiving price data at a mobile communication device for one or more products available for sale at one or more of a plurality of vending machines, wherein at least one of said prices is dependent on (at least) the identity of a purchaser of the user of the mobile communication device; and
identifying the mobile communication device to a vending machine in order to access a product at a price indicated by said price data.

12. A computer program product embodied on a computer-readable medium, said computer program including instructions which, when run on a processor, control said processor to perform:
receiving price data from a vending machine controller, wherein the price data sets prices for one or more products available for sale at a vending machine, wherein at least one of said prices is dependent on the identity of a purchaser of the product;
receiving data identifying a mobile communication device at the vending machine, wherein the identity of the mobile communication device is used to identify the purchaser; and
determining a price for a product requested by the user depending on the price data applicable.
